(19) United States
(12) Patent Application Publication
(10) Pub. No.: US 2005/0255876 A1
(43) Pub. Date: Nov. 17, 2005

(54) System and method for registering information relative to communication apparatus through communication network

(75) Inventors: Han-Chou Huang, Taoyuan (TW); Jiang-Feng Wu, SuZhou City (CN)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/122,255

(22) Filed: May 3, 2005

(30) Foreign Application Priority Data
May 4, 2004 (TW) 093112552
Aug. 31, 2004 (TW) 093126205

(51) Int. Cl. H04M 1/00

(52) U.S. Cl. 455/551; 455/556.1; 455/418; 455/435.1

(57) ABSTRACT

The present invention provides a system and method for registering information relative to a communication equipment. The system, according to the invention, includes the communication equipment, a communication network, a receiving module and a processing module. According to a preferred embodiment of the invention, the communication equipment combines data associated with the subscriber and pre-stored data associated with the communication equipment into an information including an identity code, and then sends out the information. The communication network receives and transmits the information sent from the communication equipment. The receiving module receives the information sent from the communication equipment through the communication network. The processing module, based on the identity code, selectively stores the information.

### BACKGROUND OF THE INVENTION

1. Field of the Invention

This present invention relates to a data registering system and method for registering information relative to a communication equipment, such as a mobile phone, a personal digital assistant (PDA) or the like. Moreover, in particular, the system and method according to the invention registers the information relative to the communication equipment through a communication network.

2. Description of the Prior Art

Registering information relative to a communication equipment is very important to sellers, system service providers, and manufacturers. These mentioned-above enterprises can achieve, by the establishment of data relative to the communication equipment, successive works, e.g., further maintenance service, sales statistics, customer relation managing, marketing analysis, and research on consumer behavior, and so on that benefit the development of these enterprises themselves.

Current methods for registering information relative to communication equipments are like to those for registering information relative to general consumer electronics products. These data registering methods still rely on the consumers (subscribers of the communication equipments) to fill out personal information on warrants or consumer information cards, which are sent back by consumers or retrieved by consignees. Finally, the information is collected by system service agents and is entered into data registering systems. The above process often takes couple of weeks or even longer.

Obviously, the conventional communication equipment data registering method is very inconvenient to subscribers, and there is no guarantee of plenary execution by every agent. Therefore, the conventional communication equipment data registering method is outdated, ineffective, and expensive.

Accordingly, an objective of the present invention is to provide a data registering system and method for registering information relative to a communication equipment, which is an immediate, low cost, and high achieving (convenient to subscribers) data registering system and method.

Furthermore, since the communication equipment itself is one of the communicating means to others of the subscriber, the communication network to the communication equipment should assist in registering information relative to the communication equipment.

Accordingly, another objective of the invention is to provide a data registering system and method for registering information relative to a communication equipment, and especially, by the system and method to register information relative to the communication equipment through a communication network.

In addition, the range of the information relative to the communication equipment can be very wide, e.g., personal information of the subscriber of the communication equipment, communication information regarding the communication equipment, manufacturing and selling information of the communication equipment, etc. The wider the range of information registration, the more convenient it is for analysis and application.

Accordingly, another objective of the invention is to provide a data registering system and method for registering information relative to a communication equipment, and especially, the range of the information registration is very wide.

### SUMMARY OF THE INVENTION

According to a preferred embodiment of the present invention, the data registering system and method is for registering information relative to a communication equipment through a communication network. The communication equipment is made by a manufacturer and owned by a subscriber. The data registering system communicates with a server of the manufacturer. The data registering system includes a receiving module, an accessing module, and a processing module. The receiving module is for receiving the first information transmitted from the communication equipment through the communication network, wherein the first information includes a first identity code. The accessing module is for accessing, according to the first identity code received by the receiving module, the second information from the server of the manufacturer. The processing module is for selectively storing, based on the first identity code, the first and the second information.

To apply the data registering process of the system and method according to the preferred embodiment of the present invention, the registering program built in the communication equipment is first executed. Next, the system is to judge whether the subscriber is requesting for relative registering information. If the result comes out positive, the subscriber, following the operation interface, inputs the data associated with the subscriber in sequence. Then, the communication equipment combines the data associated with the subscriber and data pre-stored in the communication equipment into the first information, and the combined information is transmitted out. Then, the communication equipment transmits the information through the communication network. Thereafter, within the communication network, an information receiving/transmitting platform appends some information into the information received. Then, the information receiving/transmitting platform, based on the required information, transmits the information received to the data registering system. Subsequently, within the data registering system, the communication network receives the information transmitted from the communication equipment. Afterward, the data registering system, based on the first identity code received, accesses manufacturing data of the communication equipment from the server. Finally, the data registering system selectively stores, based on the first identity code, the information received and accessed.

Alternatively, the communication equipment activates transmission of an information pre-stored in communication equipment when a registering function executed in the communication equipment is not completed, and when the operation of the communication equipment meets a predetermined criterion.

The advantage and spirit of the invention may be understood by the following recitations together with the appended drawings.

### BRIEF DESCRIPTION OF THE APPENDED DRAWINGS

FIG. 1 is a schematic diagram of the environments of construction and application of a data registering system 10 according to a preferred embodiment of the invention.

FIG. 2 is a flow chart diagram showing a data registering method according to a preferred embodiment of the invention.

FIG. 3 is a flow chart diagram showing a data registering method according to another preferred embodiment of the invention.

### DETAILED DESCRIPTION OF THE INVENTION

The invention provides a data registering system and method for registering information relative to a communication equipment, e.g., a mobile phone or a PDA. Especially, the system and method according to the invention is for registering information relative to a communication equipment through a communication network. Some preferred embodiments of the present invention would be explained in the following paragraph, describing the characteristics, spirit, advantages, and convenience in the application of the invention.

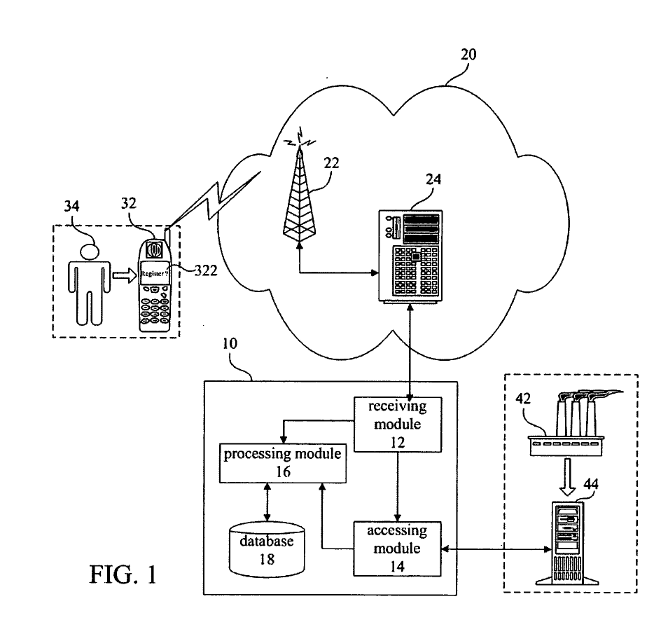

Referring to FIG. 1, FIG. 1 is a schematic diagram of the environments of the construction and application of a data registering system 10 according to a preferred embodiment of the invention. As shown in FIG. 1, the application environment illustrates that a communication equipment 32 is made by a manufacturer 42 and owned by a subscriber 34. A communication network 20 is responsible for the communication of the subscriber 34 with the outside. Also shown in FIG. 1, the manufacturer 42 has a server 44 for storing manufacturing data of the manufactured communication equipment 32. The data registering system 10 according to the invention is able to communicate with a server 44 of the manufacturer 42 through enterprise intranet, enterprise extranet, or the Internet.

Generally, the communication network 20 is managed and maintained by a system service agent. As in the environment of application shown in FIG. 1, the data registering system 10 is built outside of the communication network 20, for example, that can be a data registering system, not a component of the communication network 20, built and managed by the consignee. Besides, the data registering system 10 can also be built within the communication network 20.

As shown in FIG. 1, the data registering system 10 includes a receiving module 12, an accessing module 14, and a processing module 16.

The receiving module 12 is for receiving a first information transmitted, through the communication network 20, from the communication equipment 32. The first information includes a first identity code. In an embodiment, the first identity code is a unique international mobile equipment identity (IMEI) code. Generally, these unique IMEI codes must take cost to obtain. Therefore, the communication equipment manufacturer will use these unique IMEI codes as external controlling identity codes, i.e., these unique IMEL codes are used as the primary keys for registering the manufacturing data associated with the communication equipments been manufactured. For the convenience for database designing, the first identity code, e.g., the IMIE code, is also used as the primary key of the database for storing registration data.

The accessing module 14 is for accessing, according to the first identity code received by the receiving module 12, a second information from the server 44 of the manufacturer 42. The processing module 16 is for selectively storing, based on the first identity code, the first information and the second information. In an embodiment, as shown in FIG. 1, the data registering system 10 further includes a database 18 which stores data for the processing module 16.

In an embodiment, the first information includes a third information, inputted by the subscriber 34 into the communication equipment 32, and a fourth information pre-stored in the communication equipment 32. In practical applications, the third information includes data associated with the subscriber, e.g., name, gender, birthday, and phone number. The fourth information includes the first identity code, and it also includes other data such as communication numbers, software versions, and so on.

In another embodiment, the first information includes the first identity code, and it also includes other data such as communication numbers, software versions, and so on.

In an embodiment, the second information includes manufacturing data associated with the communication equipment 32 pre-stored in the server 44, e.g., IMEI code, sequence numbers, part numbers, model, color, manufacturing date . . . etc.

To cut down the cost for communicating, in an embodiment, the communication equipment 32 transmits the first information in a form of a short message.

Similar to a typical communication network shown in FIG. 1, in the communication network 20, a base station 22, whose associated communication area covers the communication equipment 32, is used for receiving the first information transmitted from the communication equipment 32. The communication network 20 also includes an information receiving/transmitting platform 24 for receiving the first information transmitted from the base station 22, and the platform then transmits the first information to the data registering system 10. The information receiving/transmitting platform 24 is built and managed by the system service agent. The information receiving/transmitting platform 24 can communicate with the data registering system 10 through enterprise intranet, enterprise extranet, or the Internet.

In an embodiment, the communication equipment 32 transmits, based on a pre-stored second identity code, the first information to the information receiving/transmitting platform 24, wherein the second identity code corresponds to the information receiving/transmitting platform 24. In practical applications, a common communication equipment includes a subscriber information module (SIM) card, and the second identity code is pre-stored in the card. In an embodiment, the second identity code is a mobile network code (MNC), and the communication equipment 32, based on the mobile network code, judges whether to transmit the first information to which system service agent number pre-stored in the communication equipment 32.

In the communication constructions in some countries, e.g., communication construction in Mainland China, there are also some short message platform agents besides present communication system service agents. The short message platform agents are authorized by the system service agents to send and receive massive amount of short messages in groups within the country. In the communication construction described above, the first information transmitted by the communication equipment is first received by the short message platform agents, then it is transmitted to corresponding information platforms of system service agents, based on the second identity code (such as MNC) corresponding to the information platform.

To enable the subscriber 34 to register relative information conveniently, in practical applications, a registering program is built in the communication equipment 32. The subscriber 34 can start the registering program, conveniently input relative information through the operation interface, and then send out a required information through the program. The required information represents the requirement of registering information associated with the communication equipment 32. In an embodiment, the first information includes the required information, and the information receiving/transmitting platform 24, based on the required information, transmits the first information to the data registering system 10.

If the aforesaid registering function could not be completed, for example, the registering function could not receive the response from the subscriber 34, or the registering function is rejected or interrupted by the subscriber 34, alternatively, to achieve the registration, the communication equipment 32 itself activates transmission of the first information pre-stored in communication equipment 32 when the operation of the communication equipment 32 meets a predetermined criterion. In an embodiment, the predetermined criterion is that a single duration or accumulative duration of the operation of the communication equipment 32 excess a threshold, such as 5 hours. In another embodiment, the predetermined criterion is that accumulative numbers regarding the power-on of the communication equipment 32 excesses a threshold, such as 20 times.

To extensively collect information associated with the communication equipment 32, or more specifically speaking, to collect the information of the subscriber 34 owning the communication equipment 32 for further analysis and application, in an embodiment, the information receiving/transmitting platform 24 appends a fifth information into the first information and then transmits the first information to the data registering system 10. In practical applications, the fifth information includes a communication area code according to the number the communication equipment 32 dialed and the receiving time/date of the first information, which will be used to categorize the subscriber 34 in further information analysis.

In practical applications, the processing module 16, based on the first identity code, selectively stores the first and the second information, and it also uses the first identity code as the primary key for data registering. The processing module then, according to the completeness of each piece of information, selectively registers useful data. For example, if the module lacks the contact number of the subscriber 34, then it registers the number dialed from the communication equipment 32 and the communication area code as the information of the subscriber 34.

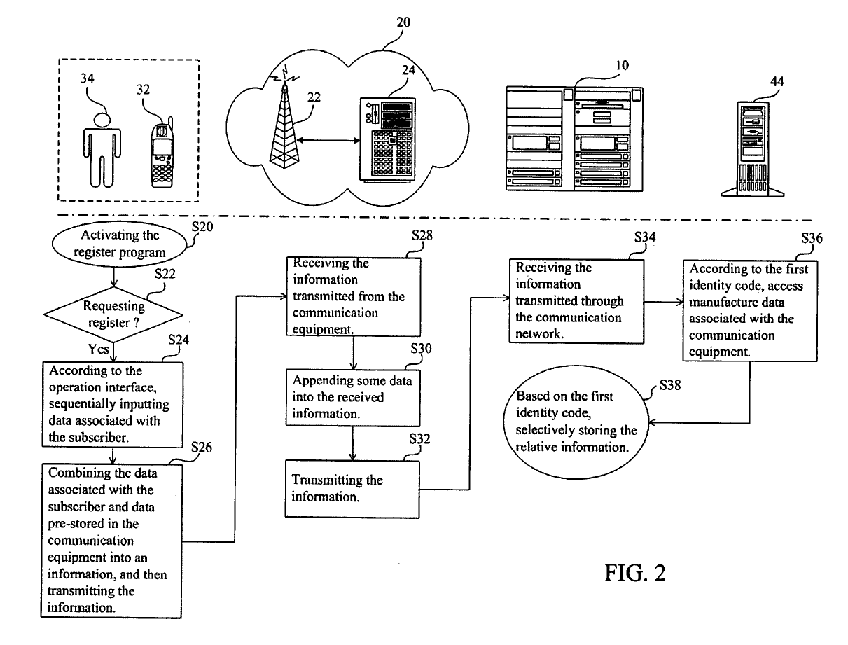

Referring to FIG. 2, FIG. 2 is a flow chart showing a data registering method according to a preferred embodiment of the invention. The data registering method as shown in FIG. 2 can be implemented by the data registering system as shown in FIG. 1. As shown in FIG. 2, the data registering method is, first, to perform step S20, and the registering program built in the communication equipment 32 is then activated. The registering program can be activated either automatically while turning on the communication equipment 32 or manually by the subscriber 34.

Next, the data registering method is to perform step S22. In step S22, it is judged whether the subscriber requests to register relative information. If the result in step S20 comes out positive that means the subscriber requests for registering, then step S24 is performed. In step S24, the subscriber 34 following the operation interface inputs relative information in sequence.

Step S26 is performed after step S24. In step S26, the communication equipment 32 combines the data associated with the subscriber 34 with data pre-stored in the communication equipment 32 into one piece of information, and it then transmits the information.

Next, execute step S28; the information is transmitted from the communication equipment 32 through the communication network 20. Then, execute step S30; within the communication network 20, the information receiving/transmitting platform 24 appends several data into the information received. Next, execute step S32; the information receiving/transmitting platform 24, based on the required information (within the information received), transmits the information received to the data registering system 10.

Afterward, by executing step S34, within data registering system 10, the information transmitted from the communication equipment 32 is received by the communication network 20. Step S36 is then performed. In step S36, the data registering system 10, based on the first identity code, accesses the manufacturing data associated with the communication equipment 32 from the sever 44.

Finally, step S38 is performed. In step S38, the data registering system 10, based on the first identity code, selectively stores information received and accessed.

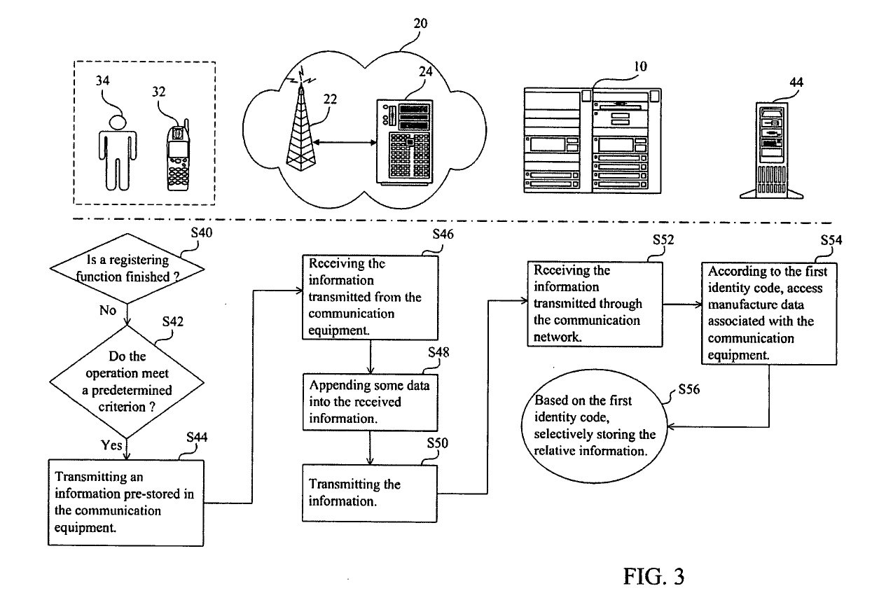

Referring to FIG. 3, FIG. 3 is a flow chart showing a data registering method according to another preferred embodiment of the invention. The data registering method as shown in FIG. 3 can also be implemented by the data registering system as shown in FIG. 1. As shown in FIG. 3, the data registering method is, first, to perform step S40 to judge whether a communication function executed in the communication equipment 32 is completed.

If NO in step S42, step S42 is then performed to judge whether the operation of the communication equipment 32 meets a predetermined criterion.

If YES in step S42, step S44 is then performed. In step S44, an information, includes a first identity code and pre-stored in the communication equipment 24, is transmitted.

Step S46 is performed after step S44. In step S46, the information transmitted from the communication equipment 32 is successively transmitted through the communication network 20.

Next, step S48 is performed. In step S48, within the communication network 20, the information receiving/transmitting platform 24 appends several data into the information received. Then, step S50 is performed. In step S50, the information receiving/transmitting platform 24, based on the required information (within the information received), transmits the information received to the data registering system 10.

Afterward, by executing step S52, within data registering system 10, the information transmitted from the communication equipment 32 is received by the communication network 20. Step S54 is then performed. In step S54, the data registering system 10, based on the first identity code, accesses the manufacturing data associated with the communication equipment 32 from the sever 44.

Finally, step S56 is performed. In step S56, the data registering system 10, based on the first identity code, selectively stores information received and accessed.

In practice, an application adapted to the data registering system 10 and method according the invention can be embedded in a current communication equipment 32. When the communication equipment 32 is powered on, the embedded application executes the steps of:
(a) judging if a registration is completed;
(b) if NO in step (a), judging if operation of the communication equipment 32 meets a predetermined criterion; and
(c) if YES in step (b), showing a default frame on the display 322 to remind the subscriber to register related data again.

According to the above explanation of the preferred embodiment of the present invention, the characteristics and advantages are clearly known as:
(a) registering information relative to the communication equipment through a communication network, thus achieving the purpose of collecting data associated with the subscriber and data associated with the communication equipment promptly and conveniently;
(b) by the registering program built in the communication equipment, guiding subscribers to conveniently input relative information, thus promoting their willingness to register, or activating the registration when the operation of the communication equipment meets a predetermined criterion, thus effectively automating the data registration;
(c) extensively collecting personal data associated with the subscribers, communication data and manufacturing data associated with the communication equipments, and sales data associated with the communication equipments . . . etc., for further data analysis and application; and
(d) by sending communication equipment information as short messages, thus cutting down the cost of collecting information.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A data registering system for registering information, comprising:
a communication equipment for activating transmission of a first information in response to occurrence of a condition, wherein the first information comprises a first identity code;
a communication network for receiving the first information and transmitting the first information when the communication equipment activates the transmission of the first information;
a receiving module for receiving the first information transmitted from the communication equipment through the communication network; and
a processing module for selectively storing, based on the first identity code, the first information.

2. The data registering system of claim 1, wherein the condition occurs when a subscriber inputs a first data associated with the subscriber, and the communication equipment combines the first data and a second data, pre-stored in the communication equipment, into the first information, and then sends out the first information.

3. The data registering system of claim 1, wherein the first information is pre-stored in the communication equipment, the condition occurs when a registering function executed in the communication equipment is not completed, and when the operation of the communication equipment meets a predetermined criterion.

4. The data registering system of claim 3, wherein the predetermined criterion is that a single duration or accumulative duration of the operation of the communication equipment or accumulative numbers regarding the power-on of the communication equipment excess a threshold.

5. The data registering system of claim 1, wherein the communication equipment is made by a manufacturer, said data registering system communicates with a server of the manufacturer, said system further comprises:
an accessing module for accessing, according to the first identity code received by the receiving module, a second information from the server of the manufacturer; and
wherein the processing module selectively stores, based on the first identity code, the first information and the second information.

6. The data registering system of claim 5, wherein the second information comprises manufacturing data associated with the communication equipment.

7. The data registering system of claim 5, wherein the first identity code is a unique international mobile equipment identity (IMEI) code.

8. The data registering system of claim 7, wherein the communication equipment sends the first information out in a form of a short message.

9. The data registering system of claim 7, wherein the communication equipment is a mobile phone or a personal digital assistant (PDA).

10. The data registering system of claim 1, wherein in the communication network, an information receiving/transmitting platform is responsible for receiving the first information sent from the communication equipment, and then transmitting the received first information, the communication equipment transmits the first information to the information receiving/transmitting platform in accordance with a pre-stored second identity code corresponding to the information receiving/transmitting platform.

11. The data registering system of claim 10, wherein the information receiving/transmitting platform functions appending a third information into the received first information, and then transmitting the first information.

12. The data registering system of claim 10, wherein the first information comprises a request information representative of the request of registering the information relative to the communication equipment, the information receiving/transmitting platform transmits, based on the request information, the first information to the receiving module.

13. The data registering system of claim 10, wherein the communication equipment comprises a subscriber information module (SIM) card, and the second identity code is pre-stored in the SIM card.

14. The data registering system of claim 13, wherein the second identity code is a mobile network code (MNC).

15. A data registering method for registering information relative to a communication equipment, said method comprising the steps of:
(a) judging if a condition occurs;
(b) if YES in step (a), activating transmission of a first information comprising a first identity code;
(c) through a communication network, receiving the first information transmitted from the communication equipment; and
(d) based on the first identity, selectively storing the first information.

16. The data registering method of claim 15, wherein the condition occurs when a subscriber inputs a first data associated with the subscriber, and in step (b), the communication equipment combines the first data and a second data, pre-stored in the communication equipment, into the first information, and then sends out the first information.

17. The data registering method of claim 15, wherein the first information is pre-stored in the communication equipment, the condition occurs when a registering function executed in the communication equipment is not completed, and when the operation of the communication equipment meets a predetermined criterion.

18. The data registering method of claim 17, wherein the predetermined criterion is that a single duration or accumulative duration of the operation of the communication equipment or accumulative numbers regarding the power-on of the communication equipment excess a threshold.

19. The data registering method of claim 15, wherein the communication equipment is made by a manufacturer, between step (c) and step (d), said method further comprises the step of:
(c-1) according to the first identity code of the first information, accessing a second information from a server of the manufacturer; and
wherein in step (d), the first information and the second information are selectively stored based on the first identity code.

20. The data registering method of claim 19, wherein the second information comprises manufacturing data associated with the communication equipment.

21. The data registering method of claim 19, wherein the first identity code is a unique international mobile equipment identity (IMEI) code.

22. The data registering method of claim 21, wherein the communication equipment sends the first information out in a form of a short message.

23. The data registering method of claim 21, wherein the communication equipment is a mobile phone or a personal digital assistant (PDA).

24. The data registering method of claim 19, wherein in the communication network, an information receiving/transmitting platform is responsible for receiving the first information sent from the communication equipment, and then transmitting the received first information, the communication equipment transmits the first information to the information receiving/transmitting platform in accordance with a pre-stored second identity code corresponding to the information receiving/transmitting platform.

25. The data registering method of claim 24, wherein the information receiving/transmitting platform functions appending a third information into the received first information, and then transmitting the first information.

26. The data registering method of claim 24, wherein the first information comprises a request information representative of the request of registering the information relative to the communication equipment; the information receiving/transmitting platform transmits, based on the request information, the first information.

27. The data registering method of claim 24, wherein the communication equipment comprises a subscriber information module (SIM) card, and the second identity code is pre-stored in the SIM card.

28. The data registering method of claim 27, wherein the second identity code is a mobile network code (MNC).

29. A communication equipment comprising an embedded application, when said communication equipment is powered on, said application executing the steps of:
(a) judging if a registration is completed;
(b) if NO in step (a), judging if operation of the communication equipment meets a predetermined criterion; and
(c) if YES in step (b), showing a default frame.

30. The communication equipment of claim 29, wherein the predetermined criterion is that a single duration or accumulative duration of the operation of the communication equipment or accumulative numbers regarding the power-on of the communication equipment excess a threshold.
